(19) United States
(12) Patent Application Publication
(10) Pub. No.: US 2026/0093438 A1
(43) Pub. Date: Apr. 2, 2026

(54) PHYSICAL ACTION OF MOBILE DEVICE TOWARDS CONNECTED DEVICE TO DISPLAY CONTENT

(71) Applicant: Lenovo (United States) Inc., Morrisville, NC (US)

(72) Inventors: Christopher Smith, Franklinton, NC (US); Rod D. Waltermann, Rougemont, NC (US); Wenyu Du, Beijing (CN); Jung Hwan Hong, Cary, NC (US)

(21) Appl. No.: 18/902,742

(22) Filed: Sep. 30, 2024

(51) Int. Cl. G06F 3/14; G06F 3/0346

(52) U.S. Cl. CPC G06F 3/1454; G06F 3/0346

(57) ABSTRACT

One embodiment provides a method, including: detecting, at a device with output content, a gesture from a user, wherein the gesture causes a movement of the device; connecting, the device and another device, wherein the another device is located in a direction along the movement of the device; and displaying, using the connection, the output content upon the another device Other aspects are claimed and described.

### BACKGROUND

Two electronic devices may be used simultaneously by a user. A device which may be hand-held, portable, or connected to streaming services may have a smaller display screen. Another device, such as a television, monitor, and/or the like, may be present and provide a better display option that is larger, better resolution, or audio. A user may wish to connect the two devices such that the hand-held device may send the media to the other device.

### BRIEF SUMMARY

In summary, one aspect provides a method, the method comprising: detecting, at a device with output content, a gesture from a user, wherein the gesture causes a movement of the device; connecting, the device and another device, wherein the another device is located in a direction along the movement of the device; and displaying, using the connection, the output content upon the another device.

Another aspect provides a system, the system comprising: a device with output content; another device; a movement sensor; a processor; a memory device that stores instructions that, when executed by the processor, causes the system to: detect, at the device with output content, a gesture from a user, wherein the gesture causes a movement of the device; connect, the device and the another device, wherein the another device is located in a direction along the movement of the device using the movement sensor; and display, using the connection, the output content upon the another device.

A further aspect provides a product, the product comprising: a computer-readable storage device that stores executable code that, when executed by a processor, causes the product to: receive, at a device with output content, a gesture from a user, wherein the gesture causes a movement of the device; connect, the device and another device, wherein the another device is located in a direction along the movement of the device; and display, using the connection, the output content upon the another device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for displaying output content on another device based upon detecting a physical action of a mobile device towards a connected device to display content.

FIG. 4 illustrates an example portion of a gesture for a physical action of a mobile device towards a connected device to display content.

FIG. 5 illustrates another example portion of a gesture for a physical action of a mobile device towards a connected device to display content.

FIG. 6 illustrates a further example portion of a gesture for a physical action of a mobile device towards a connected device to display content.

### DETAILED DESCRIPTION

A user may have content on a small display such as a mobile phone, tablet, and/or the like, and may want to ‘cast’ or ‘screen mirror’ the content onto another larger display. There are many steps required to display what is on one device onto another device. Additionally, users may experience difficulties in selecting the correct device for screen sharing when multiple devices are nearby. Current methods require users to manually identify devices by their names, which slows down the sharing process and complicates user interactions, especially when more than two devices are involved.

For example, YouTube® has a cast function in which a person can press a button within YouTube then choose a destination device (YouTube is a registered trademark of Google LLC in the United States and other countries). This requires multiple actions, and specific software. This and other similar solutions also depend on the user knowing the name of the device they intend to cast to. The described system and method does not have that requirement. Additionally, the described system and method allows a person to cast their screen to another device regardless of software running, with a single action, provided that the two devices are already given permissions between them.

As another example, Apple®'s ‘screen mirror’ function requires the user to pull down the window on their phone, then select the nearby device from a list, then enter a code to confirm (Apple is a registered trademark of Apple Inc. in the United States and other countries). This requires multiple steps that the user has to perform. The described system and method only requires the user to provide a single gesture that casts the content from one device to another. Additionally, the system is able to identify which device to transfer the content to even if there are more than one device within the vicinity. The described system and method uses a physical action as a trigger that essentially executes multiple actions with one step and is able to determine which device is to receive the ‘cast’ or ‘screen mirror’ based on the location and direction of the physical action.

Accordingly, the described system provides a technical improvement over traditional methods for connecting two devices and transferring content from one device to another. In particular, the method and system allow a user to easily cast, mirror, or send content from one device to another. The content may be information contained on a display, audio, data, and/or a combination thereof. The system detects of a user gesture. The gesture may be a movement of a device with the content in a direction towards another device the user wants to display or output the content upon. The gesture may be an abrupt action or a slower sweeping action. For example, the gesture or movement may be a whip, stab, swing, and/or the like, of the device in a direction toward the another device. The system may utilize at least one accelerometer or other component capable of sensing location and direction of movement operatively coupled to the device. As an example, a user may be displaying content upon a mobile phone in the hand of the user, and the user may move the mobile phone in a direction of a monitor to display, cast, or mirror the display upon the monitor. The two devices may be previously connected. In other words, the device may be paired prior to the casting. Accordingly, the system provides a system and method that is more efficient, faster, and more user-friendly than conventional techniques that require a user to provide further input.

The illustrated example embodiments will be best understood by reference to the figures. The following description is intended only by way of example, and simply illustrates certain example embodiments.

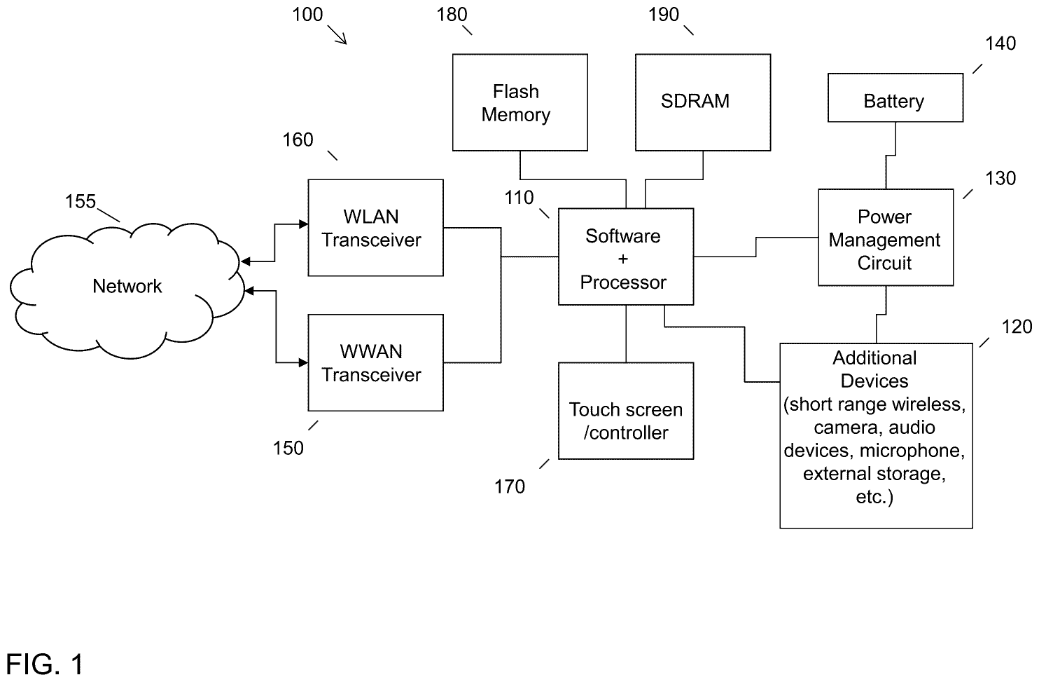

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

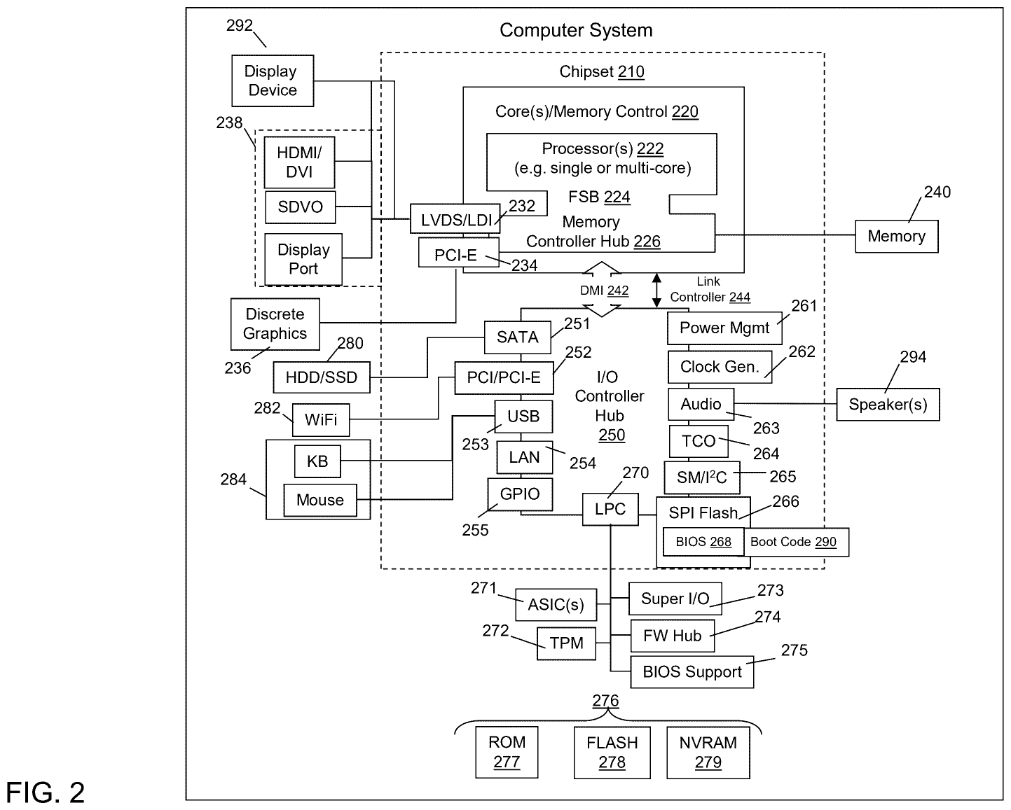

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used to cast or mirror content on another device. For example, the circuitry outlined in FIG. 1 may be implemented in a tablet or smart phone embodiment, whereas the circuitry outlined in FIG. 2 may be implemented in a personal computer embodiment.

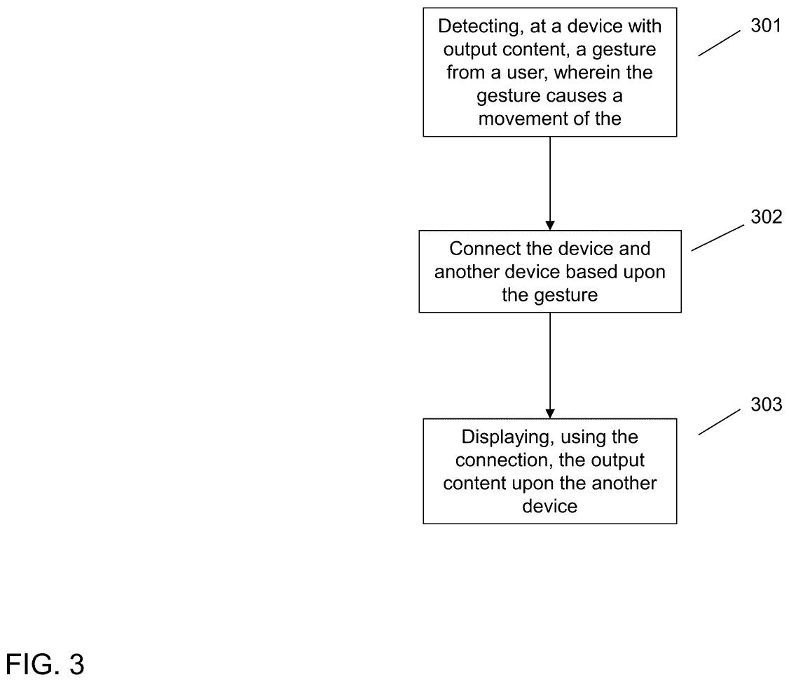

FIG. 3 illustrates an example method for displaying output content on another device based upon detecting a physical action of a mobile device towards a connected device to display content. The method may be implemented on a system which includes a processor, memory device, output devices (e.g., display device, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to cast or mirror content on another device. Additionally, the casting system includes modules and features that are unique to the described system.

Activation of the device casting or mirroring system may be a manual activation of the device casting or mirroring system and/or an automatic activation of the device casting or mirroring system. Manual activation of the system may include a user opening an application associated with the device casting or mirroring system, the user accessing a computing system associated with the device casting or mirroring system, and/or the user otherwise providing input to the device casting or mirroring system. The automatic activation of the device casting or mirroring system may be based upon the detection of a trigger event indicating that the system should be activated. Example trigger events include a user accessing a system or application that is accessible by the device casting or mirroring system, detection of a user moving a device in a direction toward another device, activation of software or an application utilizing the device mirroring or casting system, and/or the like.

The device casting or mirroring system may be made of multiple systems or modules that communicate together to make up the device casting or mirroring system or may be a single system. The device casting or mirroring system may be a standalone system, may be accessible through other computing devices, and/or a combination thereof. For example, the device casting or mirroring system may be a standalone system that can be accessed by a user and/or may be provided as an application that is accessible by a user on a computing device. The device casting system may be accessible using any type of computing device, for example, a personal computer, laptop computer, smartphone, tablet, smartwatch, smart television, smart appliance, augmented reality device, virtual reality device, and/or the like.

Thus, the device casting or mirroring system may be accessible locally using a computing device where the device casting or mirroring system is installed and/or may be accessible remotely through another computing device. For example, the device casting or mirroring system may be accessed by a user using a device that communicates with the device casting or mirroring system to receive a movement or gesture from a user, detect another device in the direction of the movement of the device, and/or the like. However, the device casting or mirroring system may be located and operate on a different information handling device as compared to the device being utilized by the user to perform the described steps.

The gesture or movement of the device, and the connecting the device to the another device can be provided as a service to other entities or companies. In other words, the device casting or mirroring system could be stored on a server or network of a company and the system could receive and respond to a connection between the two devices, with the other companies or entities paying for the creation of refined connection for casting of mirroring of content to another system or other use of the query response refinement and transfer system.

The device casting or mirroring system may have an associated graphical user interface. The graphical user interface may be provided on a display or monitor, which may or may not be associated with the device casting or mirroring system. In other words, the device casting or mirroring system may have a dedicated display or monitor or may be accessible using any display or monitor. In either case, the device casting or mirroring system may provide instructions to generate and display the graphical user interface on the display device being used to access the device casting or mirroring system. The graphical user interface may also be updated and managed based upon instructions provided by the device casting or mirroring system. In other words, the device casting or mirroring system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the device casting or mirroring system. For example, the device casting or mirroring system may utilize a user profile, historical information, a database of movement gestures, and/or the like, to identify how to treat a gesture or movement received from the user, when a device connection has been created, when content should be transferred, and/or the like. The graphical user interface may allow for creation of or access to these profiles, historical information, and/or the like, by allowing a user to input information regarding user preferences, casting or mirroring system preferences, and/or the like. As will be discussed in more detail, the use of user provided information is not the only way that the profile and/or historical information can be created. The device casting or mirroring system can then utilize these inputs to create the profile(s), store the historical information, identify when content should be transferred or cast, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, information of the casting or mirroring system, and/or the like. It should be noted that the information to be used by the device casting or mirroring system and information provided by the device casting or mirroring system can be different for different applications, different computing systems, different users, and/or the like. Thus, the information corresponding to input or output of the device casting or mirroring system are not always the same. However, the device casting or mirroring system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The device casting or mirroring system may utilize one or more artificial intelligence models in receiving an indication for transferring content from at least one additional device to an information handling device, determining when to present a graphical user interface associated with the received pairing input, when determining that content should be transferred and to which device to transfer the content, and/or the like. Artificial intelligence models may also be used for steps within a step. For example, a model could be utilized to receive information from sensors, such as an accelerometer, input regarding an indication for transferring content, and/or the like. As another example, a model could be utilized to receive inputs regarding a location or position of at least one additional device with respect to an information handling device, identify pairing inputs related to how a user is utilizing the device pairing system, and/or the like, to determine when content should be transferred from at least one device to an information handling device and what device to which the content should be transferred.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the query response refinement and transfer system or may be a model that is created from scratch. Since the device casting or mirroring system is used in conjunction with displaying content on another device, some models that may be utilized by the system are gesture analysis models, image analysis models, audio analysis models, other analysis models, entity identification models, similarity identification models, language models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machines, extreme gradient boosting, multimodal machine learning, unsupervised learning models, deep learning models, transformer models, inference models, and/or the like, including models that may be developed in the future. The chosen model structure may be dependent on the particular task that will be performed with that model.

The device casting or mirroring system may include different components for carrying out different functions of the system, including different steps to be performed. These components may be hardware components or software components. Some hardware components may include sensors (e.g., biometric sensors, image capture devices, proximity sensors, microphones, accelerometers, activity trackers, health metric sensors, etc.) that can be used to detect a gesture, identify a device for content transfer, and/or the like. Input devices may be utilized to assist with performing steps of the described system and method, and/or the like, for example, mechanical input modalities (e.g., keyboard, mouse, etc.), touch input devices, gesture input devices, electromyography input devices, audio input devices, and/or the like. Other hardware components may be utilized to perform steps of the described system and method.

One software component may include a user profile which may be unique to a user and may assist in determining when and how content should be transferred from one device to another. The user profile may include user preferences. For example, the user profile may identify a default or preferred content transfer device, may identify when content should be transferred, may identify a gesture or movement used by the user to perform the content transfer, and/or the like. The user may manually input this data into the profile or the information may be populated by the system as the system learns about the user over time. For example, the system may utilize an artificial intelligence model to learn about the user, make correlations between devices and content transfer, make correlations between gestures and content transfer, and/or the like. This information can be populated within the user profile for use by the system during subsequent device casting or mirroring determinations. The user profile may also include other information about the user that seems to influence content transferring, for example, a location of use of a device and associated content transfers, devices that are paired based upon an environment or context of the user, a proximity of other users during a content transfer, and/or the like.

Referring to FIG. 3 at 301, the method and system may detect a gesture or movement from a user. The device may be outputting content, for example, content on a display screen, content through a speaker, and/or the like. Thus, content may refer to display information, audio information, data, and/or the like. The content may be streaming from a network, internal storage, remote storage, a cloud, another device, and/or the like. The content may be a current output on the device, in a queue for consumption, available or accessible to the device, and/or the like. The content may be dynamic and changing over time. As an example, the content may be a video upon a display of the device with corresponding audio.

The device may be hand-held or capable of being moved by a user, for example, a smart phone, a tablet, a laptop, a smart watch, and/or the like. The user may perform a gesture or a movement of the device. The gesture or movement may be a default gesture or movement, configured by the user, identified in the user profile, learned by the system over time, identified using the artificial intelligence model, and/or the like. Example gestures or movements include, but are not limited to, a snapping motion, a whipping motion, a sweeping motion, an arcing motion, and/or the like. These are merely illustrative examples and are not intended to be limiting.

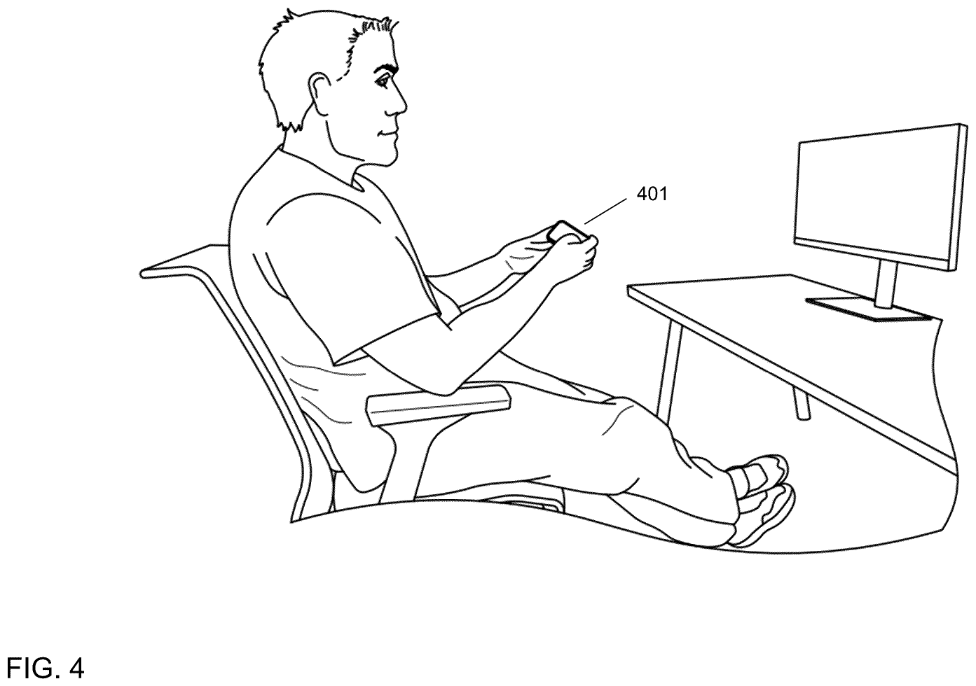

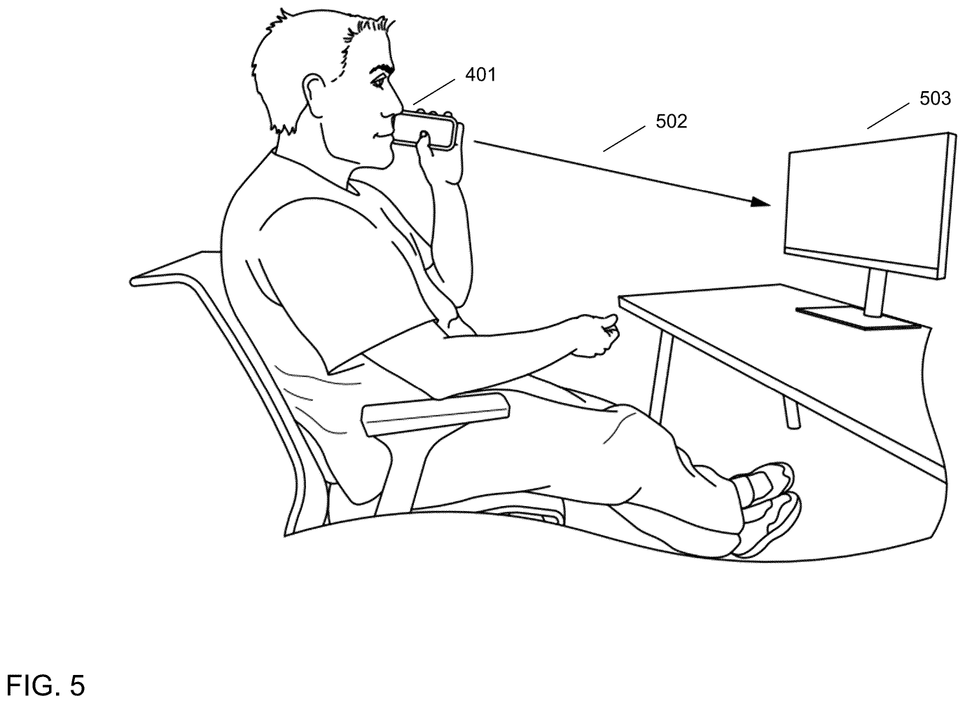

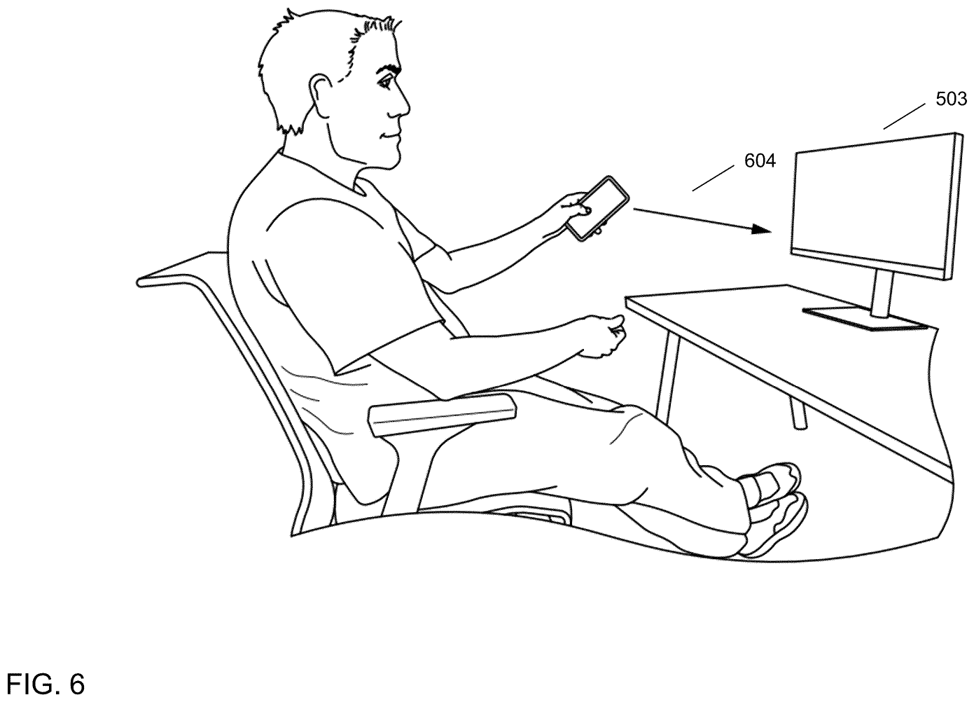

The device may detect and determine a direction of movement of the device. The detecting and determining may be performed by accelerometers, gyroscopes, motion sensors, proximity sensors, and/or any sensor capable of sensing a movement and/or a direction of movement of the device. Referring to FIG. 4, FIG. 5, and FIG. 6, an example motion or gesture is shown in successive panels. For example, the user may be holding a hand-held device 401 (FIG. 4), move the handheld device 401 in a motion of a gesture 502 toward another device 503 (FIG. 5), and continue that motion 604 toward the another device 503 (FIG. 6).

At 302, the system may connect the device (the device that was included in the movement, referred to as the handheld device for ease of readability) and the another device (the device that the movement was directed towards, referred to as the receiving device for ease of readability) based upon detection of the movement at 301. In other words, in order to transfer content to the receiving device, the handheld device and the receiving device may need to be connected, paired, or otherwise set up for communication therebetween. Thus, responsive to detecting the gesture, the system may connect the handheld device and the receiving device so that they are communicating with each other. Alternatively, the connecting of the handheld device and the receiving device could occur before detection of the gesture. In other words, step 302 could occur before step 301. Thus, order of these steps is not limited to step 302 occurring after step 301. Accordingly, the two devices, such as the handheld device and the receiving device, may be previously paired. In other words, prior to the casting of content the two devices may have been paired using authentication codes, a handshake, a form of authentication, shared or accepted user ID, and/or the like. These pairing techniques can also be used after detection of the gesture.

In addition to detecting the gesture, the system may also detect a direction of the gesture with respect to other devices within an environment. In order to ensure that the content is transferred to the device the user intended, the system may know the relative location between devices. In other words, the system may know where the handheld device is located relative to other devices within the environment and may also know where the other devices within the environment are with respect to each other. Thus, from the direction of the gesture, the system can identify which of the devices is the receiving device.

For example, in an environment where the user is utilizing a phone as the handheld device and the environment includes a tablet device and personal computing device. Additionally, in this example, the phone is connected to both the tablet device and the PC device. The user can ‘whip’ their phone towards the tablet and the system would distinguish that the tablet is the receiving device and not the PC device. Thus, the content will be transferred to the tablet device and not onto the PC device.

At 303, the system may display the content included on the handheld device to the receiving device. This may include transferring the content to the receiving device and stopping the display of the content on the handheld device, mirroring the content so that it is displayed on both devices, and/or the like. Thus, the method and system may cast, mirror, pair, and/or the like, to or with another device. As an example, the device moved by the user may cast or mirror content upon another device. Thus, the content that is displayed on the device with which the movement was performed, may be casted or mirrored on another device. Using the movement data and the relative location of the two or more devices, a user can stream or cast between devices. If a user has two or more other devices connected, the device will stream to receiving device or devices that the handheld device is whipping or moved towards and not the other device within the environment. A user motion or gesture may include a whip, stab, sweep, flick, swing, and/or the like. Therefore, with a simple gesture or movement of a user, a device may cast content to another device. The receiving device which begins displaying the content is in the direction of the movement or gesture of the device.

If the system is unable to differentiate the movement among several devices, the system and method may take additional actions. For example, the system may use the movement to make a best judgement as to the receiving device. As another example, the system may use the movement data to cast content to one of the possible receiving devices along the closest movement path. The system may then wait for the user to attempt another gesture or movement to perform the mirroring. In other words, the system may make a selection and then if the user attempts to perform the gesture again, the system may understand that the selected receiving device was incorrect. On the other hand, if the user does not attempt to perform the gesture again, the system may understand that the selected receiving device was correct.

As another potential action, the system may prompt the user about the ambiguity of the movement and request the user perform another movement, select from a list of possible devices, and/or the like. As another potential action, the method and system may use a historical database of previous actions and/or casting from the user to assist in determining the receiving device. For example, if the user typically casts from a mobile device to a computer monitor during work hours, but casts from a mobile device to a nearby television in non-work hours, this information can be utilized to assist in determining the receiving device. As another example, the user may have a history of casting to a particular device in a particular setting such as a room, a vehicle, upon a particular network, and/or the like, which can then be utilized to assist in determining the receiving device. It should be noted that these examples are merely illustrative examples and is not intended to be limiting. The described system and method can be utilized in many different applications and situations.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” and/or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated. Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, the method comprising:
detecting, at a device with output content, a gesture from a user, wherein the gesture causes a movement of the device towards another device, wherein the detecting comprises distinguishing between the another device and a further device in close proximity to the another device;
connecting the device and the another device, wherein the another device is located in a direction along the movement of the device; and
displaying, using the connection, the output content upon the another device.

2. The method of claim 1, wherein the output content comprises an image to display upon the another device.

3. The method of claim 1, wherein the output content comprises an audio sound to output from the another device.

4. The method of claim 1, wherein the connecting continues providing the output content in real-time upon the another device.

5. The method of claim 1, wherein the movement comprises a snapping motion by the user of the device in the direction of the another device.

6. The method of claim 1, wherein the movement comprises a sweeping-type motion by the user of the device in the direction of the another device.

7. The method of claim 1, wherein the direction is determined using at least one accelerometer operatively coupled to the device.

8. The method of claim 1, wherein the connecting the device and the another device comprises near-field communication.

9. (canceled)

10. The method of claim 1, wherein the connecting occurs before the detecting.

11. A system, the system comprising:
a device with output content;
another device;
a movement sensor;
a processor;
a memory device that stores instructions that, when executed by the processor, causes the system to:
detect, at the device with output content, a gesture from a user, wherein the gesture causes a movement of the device towards another device, wherein to detect comprises distinguishing between the another device and a further device in close proximity to the another device;
connect the device and the another device, wherein the another device is located in a direction along the movement of the device using the movement sensor; and
display, using the connection, the output content upon the another device.

12. The system of claim 11, wherein the output content comprises an image to display upon the another device.

13. The system of claim 11, wherein the output content comprises an audio sound to output from the another device.

14. The system of claim 11, wherein the connecting continues providing the output content in real-time upon the another device.

15. The system of claim 11, wherein the movement comprises a snapping motion by the user of the device in the direction of the another device.

16. The system of claim 11, wherein the movement comprises a sweeping-type motion by the user of the device in the direction of the another device.

17. The system of claim 11, wherein the direction is determined using at least one accelerometer operatively coupled to the device.

18. The system of claim 11, wherein the connecting the device and the another device comprises near-field communication.

19. (canceled)

20. A product, the product comprising:
a computer-readable storage device that stores executable code that, when executed by a processor, causes the product to:
receive, at a device with output content, a gesture from a user, wherein the gesture causes a movement of the device towards another device, wherein to receive comprises distinguishing between the another device and a further device in close proximity to the another device;
connect the device and the another device, wherein the another device is located in a direction along the movement of the device; and
display, using the connection, the output content upon the another device.

21. The method of claim 1, wherein the detecting the gesture from the user towards the another device comprises confirming connection between the device and the another device;
wherein the confirming comprises at least one of: repeating the gesture, performing another movement, and not attempting to repeat the gesture.

22. The method of claim 21, wherein the not attempting to repeat the gesture indicates the another device that received the gesture is the correct another device.
